(19) United States
(12) Patent Application Publication
(10) Pub. No.: US 2016/0118668 A1
(43) Pub. Date: Apr. 28, 2016

(54) CARBON ADDITIVES FOR NEGATIVE ELECTRODES

(71) Applicant: Cabot Corporation, Boston, MA (US)

(72) Inventors: Aurelien L. DuPasquier, Westford, MA (US); Paolina Atanassova, Waltham, MA (US); David V. Miller, Arlington, MA (US); Miodrag Oljaca, Concord, MA (US)

(21) Appl. No.: 14/867,117

(22) Filed: Sep. 28, 2015

Related U.S. Application Data
(60) Provisional application No. 62/067,051, filed on Oct. 22, 2014.

(51) Int. Cl. H01M 4/62; H01M 4/38

(52) U.S. Cl. CPC H01M 4/628; H01M 4/627; H01M 4/625; H01M 4/387; H01M 2004/027

(57) ABSTRACT

Disclosed herein are compositions comprising: a carbon additive prewetted with an acid (e.g., H₂SO₄); and a lead-containing material. Also disclosed are methods of making such compositions, and pastes and electrodes made therefrom.

### CROSS REFERENCE TO RELATED APPLICATION

This application claims the benefit of U.S. Provisional Application No. 62/067,051, filed on Oct. 22, 2014, hereby incorporated by reference.

### FIELD OF THE INVENTION

Disclosed herein are carbon additives for negative electrodes, which can be incorporated in lead-acid batteries.

### BACKGROUND

There is a continual need to improve the performance of lead acid batteries. Metrics for battery performance include cycle life, dynamic charge acceptance (DCA), water loss, and cold crank ability.

Controlling water loss is a consideration in the design of low-maintenance or maintenance-free lead acid batteries. Water loss in lead acid batteries occurs during charge and over-charge, and is due to the evolution of hydrogen on the negative plate and oxygen evolution on the positive plate. The water loss in lead acid batteries is affected by the positive and negative plate potentials during charge, and can be influenced by the presence of certain metal impurities in the acid electrolyte, grids and electrode components. However, the addition of carbon in the negative plates typically leads to increased water loss. Moreover, small particle carbon can fill in the pores of the composition or promote formation of smaller lead crystallites resulting in reduced median pore size.

Expanders (e.g., organic molecules such as lignosulfonate) are also present in electrode composition to retard undesired PbSO₄ film growth by adsorbing onto and coating the lead surface. The lignosulfonate promotes formation of a porous PbSO₄ solid and prevents growth of a smooth PbSO₄ layer. The lignosulfonate, however, has a tendency to adsorb onto the carbon surface, reducing its availability for coating the lead surface that helps prevent the formation of the PbSO₄ passivating layer.

Accordingly, there remains a need to develop carbon additives that can help achieve improved dynamic charge acceptance (DCA) and cycle life while maintaining and/or decreasing water loss.

### SUMMARY

One embodiment provides a composition comprising:
a carbon additive prewetted with an acid (e.g., H₂SO₄); and
a lead-containing material.

Another embodiment provides a method of making a paste comprising a negative active material composition, comprising:
combining a carbon additive with an acid (e.g., H₂SO₄) to form an acid prewetted carbon additive;
forming the paste comprising the acid prewetted carbon additive and a lead-containing material.

### BRIEF DESCRIPTION OF THE DRAWING(S)

FIG. 1 is a plot of cycle no. as a function of end of discharge voltage;

FIG. 2. is a photograph of a wet powder of Example 3;

FIG. 3. is a photograph of a wet powder of Example 4;

FIG. 4. is a photograph of a wet slurry of Example 5;

### DETAILED DESCRIPTION

Disclosed herein are carbon additives for NAM compositions (e.g. negative active mass), which can be used as electrode compositions for lead acid batteries.

It has been discovered that carbon additives added to electrode compositions can improve conductivity, crystallite growth control, and electron transfer processes. Certain grades of carbon additives, however, are sufficiently hydrophobic to render them less compatible with components in typical electrode compositions in an aqueous paste. It has been discovered that prewetting the carbon additive with at least one acid prior to combining with a negative active mass can provide an electrode composition in which cycle life can be improved without a deleterious increase in water loss. Accordingly, one embodiment provides a composition comprising:
a carbon additive prewetted with H₂SO₄; and
a lead-containing material.

In one embodiment, a carbon additive “prewetted with H₂SO₄” (or acid-prewetted carbon additive) refers to a material that is pretreated with the H₂SO₄ prior to combining the additive with a NAM material, e.g., a NAM material for lead-acid batteries. Without wishing to be bound by any theory, the acid-prewetting can result in one or more of the following: (a) higher hydrophilicity of the acid-pre wetted carbon relative to the untreated carbon (e.g., as indicated by surface energy measurements), which can result in better dispersion in aqueous pastes; (b) surface oxidation of the carbon surface (e.g., carbon black surface) resulting in functional groups such as hydroxyls or carboxylates, which can assist lead adsorption and plating on the carbon surface, resulting in higher lead surface available for charge acceptance and smaller lead sulfate crystal growth during partial state of charge cycling; and (c) saturation of carbon porosity with sulfuric acid, which can result in maintenance of an ideal leady oxide/sulfate ratio in the paste—typically, the presence of carbon would normally soak a fraction of the available sulfuric acid.

The acid-prewetting step can be performed according to any method known in the art. In one embodiment, the acid is added dropwise to the carbon additive. In another embodiment, the carbon additive is slowly added to a volume of acid, the volume optionally containing extra water. In one embodiment, the acid is H₂SO₄, which is also typically present in a NAM paste. The H₂SO₄ can have a density ranging from 1.05 g/cm³ to 1.5 g/cm³.

Carbon additives can be selected from carbonaceous materials known in the art, including carbon black, graphenes (including few layer graphenes), graphite, activated carbon, carbon fibers and nanofibers, carbon nanotubes, and expanded graphite. Exemplary carbon additives are available commercially from Cabot Corporation (e.g., PBX™ 135 carbon black additive).

In one embodiment, the ratio of acid to carbon additive is determined by the properties of the carbon surface, e.g., surface area, oil absorption number (OAN), etc. In embodiment, the carbon additive is selected from carbon black where the carbon black is prewetted with H₂SO₄ in an amount ranging from 0.5×OAN to 2×OAN of the carbon black or between 0.6 L and 2.4 L of acid per kg of carbon wherein H₂SO₄ has a density ranging from 1.05 g/cm³ to 1.5 g/cm³. OAN can be determined according to ASTM-D2414 with units of g/100 mL. For example if the carbon black has OAN of 120 mL/100 g, the amount of H₂SO₄ applied to the carbon black would equal to 0.5*120 mL/100 g, or 60 mL/100 g (0.6 L H₂SO₄/1 kg of carbon black) up to 2*120 mL/100 g or 240mL/100 g (2.4 L of acid for 1 kg carbon black. In another embodiment, the carbon black is prewetted with H₂SO₄ in an amount ranging from 0.5×OAN to 1.5×OAN of the carbon black, e.g., from 0.5×OAN to 1.2×OAN, from 0.8×OAN to 2×OAN, from 0.8×OAN to 1.5×OAN, or from 0.8×OAN to 1.2×OAN of the carbon black.

In one embodiment, the carbon black has an OAN ranging from 50 mL/100 g to 500 mL/100 g, e.g., from 50 to 460 mL/100 g, from 80 to 350 mL/100 g, from 100 to 250 mL/100 g, from 130 mL/100 g to 220 mL/100 g, or from 130 mL/100 g to 220 mL/100 g.

In another embodiment, the carbon additive has a surface area (BET) ranging from 1 m²/g to 3000 m²/g (e.g., graphites having a surface area ranging from 1 m²/g to 50 m²/g), or from 10 m²/g to 3000 m²/g, such as surface area ranging from 10 m²/g to 2500 m²/g, from 10 m²/g to 2000 m²/g, from 50 m²/g to 3000 m²/g, from 50 m²/g to 2500 m²/g from 50 m²/g to 2000 m²/g, from 100 m²/g to 3000 m²/g, from 100 m²/g to 2500 m²/g, or from 100 m²/g to 2000 m²/g. The BET surface area can be determined according to ASTM-D6556.

In one embodiment, the surface energy of the carbon additive increases as a result of the acid-prewetting. The increased surface energy can indicate a higher hydrophilicity of the carbon surface. The surface energy (SE) of carbon black samples was determined by measuring the water vapor adsorption using a gravimetric instrument. The carbon black sample was loaded onto a microbalance in a humidity chamber and allowed to equilibrate at a series of step changes in relative humidity. The change in mass was recorded. The equilibrium mass increase as a function of relative humidity was used to generate the vapor sorption isotherm. Spreading pressure (in mJ/m²) for a sample is calculated as πₑ/BET, in which:

$${π}_{e} = RT {\int }_{0}^{{p}_{0}} Γ d ln p$$

and R is the ideal gas constant, T is temperature, Γ is moles of water adsorbed, p₀ is the vapor pressure, and p is the partial pressure of the vapor at each incremental step. The spreading pressure is related to the surface energy of the solid and is indicative of the hydrophobic/hydrophilic properties of the solid, with a higher surface energy (SE) corresponding to a higher hydrophilicity.

In one embodiment, a surface energy of the acid-prewetted carbon additive is at least 25% greater than that of the carbon additive (before acid-prewetting), when measured in units mJ/m². In another embodiment, the surface energy of the acid-prewetted carbon additive is at least 50% greater, at least 100% greater, at least 150%, at least 200% greater, at least 500% greater, or at least 1000% greater than that of the carbon additive.

In one embodiment, the carbon additive prewetted with H₂SO₄ is a powder, e.g., a wet powder. In one embodiment, the powder (e.g., wet powder) can have a granular or agglomerated consistency so long as the powder is sufficiently free flowing. In another the carbon additive prewetted with H₂SO₄ is a slurry.

In one embodiment, the lead-containing material is selected from lead, PbO, leady oxide, Pb₃O₄, Pb₂O, and PbSO₄, hydroxides, acids, and metal complexes thereof (e.g., lead hydroxides and lead acid complexes). In one embodiment, lead-containing material comprises leady oxide. In another embodiment, the homogeneous mixture further comprises BaSO₄ and/or additional H₂SO₄ (i.e., in addition to the H₂SO₄ used to prewet the carbon additive).

In one embodiment, the carbon additive prewetted with H₂SO₄ is present at a dry weight fraction of 0.1% to 5% by weight, relative to the total weight of the lead-containing material, e.g., relative to the total weight of leady oxide.

In one embodiment, the homogeneous mixture further comprises an organic molecule expander. “Organic molecule expander” as defined herein is a molecule capable of adsorbing or covalently bonding to the surface of a lead-containing species to form a porous network that prevents or substantially decreases the rate of formation of a smooth layer of PbSO₄ at the surface of the lead-containing species. In one embodiment, the organic molecule expander has a molecular weight greater than 300 g/mol. Exemplary organic molecule expanders include lignosulfonates, lignins, wood flour, pulp, humic acid, and wood products, and derivatives or decomposition products thereof. In one embodiment, the expander is selected from lignosulfonates, a molecule having a substantial portion that contains a lignin structure. Lignins are polymeric species comprising primarily phenyl propane groups with some number of methoxy, phenolic, sulfur (organic and inorganic), and carboxylic acid groups. Typically, lignosulfonates are lignin molecules that have been sulfonated. Typical lignosulfonates include the Borregard Lignotech products UP-393, UP-413, UP-414, UP-416, UP-417, M, D, VS-A (Vanisperse A), Vanisperse-HT, and the like. Other useful exemplary lignosulfonates are listed in, “Lead Acid Batteries”, Pavlov, Elsevier Publishing, 2011, the disclosure of which is incorporated herein by reference.

In one embodiment, the organic molecule expander is present in an amount ranging from 0.05% to 1.5% by weight, e.g., from 0.2% to 1.5% by weight, or from 0.3% to 1.5% by weight, relative to the total weight of the electrode composition.

In one embodiment, the composition is a homogeneous mixture, e.g., the acid-prewetted carbon additive and the at least the lead-containing material are uniformly interspersed with each other. In one embodiment, none of the components of the homogeneous mixture are provided as layers or coatings. In another embodiment, the homogeneous mixture further comprises BaSO₄ and/or additional H₂SO₄ (i.e., in addition to the H₂SO₄ used to prewet the carbon additive) and/or the organic molecule expander. In one embodiment, the BaSO₄ and/or additional H₂SO₄ and/or organic molecule expander are uniformly interspersed with the lead-containing material and the carbon additive.

In one embodiment, the composition comprises a paste (e.g., an aqueous) paste or slurry that can function as a NAM paste for an electrode.

In one embodiment, the carbon additive is present in the composition in an amount ranging from 0.1% to 2% by weight, relative to the total weight of the composition.

Another embodiment provides a method of making a paste comprising a negative active material composition, comprising:
combining a carbon additive with H₂SO₄ to form an acid prewetted carbon additive;
forming the paste comprising the acid-prewetted carbon additive and a lead-containing material.

In one embodiment, the step of combining the carbon additive with H₂SO₄ can be performed as known in the art e.g., adding H₂SO₄ slowly (e.g., dropwise) to the carbon additive or adding the carbon additive slowly to a volume of the H₂SO₄, optionally containing additional water.

In one embodiment, the step of combining the carbon additive with H₂SO₄ is performed for no more than 24 h, e.g., no more than 12 h, no more than 8 h, no more than 4 h, no more than 2 h, or no more than 1 h. In another embodiment, the carbon additive is prewetted with H₂SO₄ for a time period sufficient to achieve a surface energy of the acid-prewetted carbon additive that is at least 25% greater than that of the carbon additive (before acid-prewetting), or any of the increases disclosed herein.

In one embodiment, forming the paste comprises adding water to the acid-prewetted carbon additive to form a slurry, and adding to the slurry, in any order, lignosulfonate, BaSO₄, the lead-containing material (e.g., leady oxide), an additional volume of H₂SO₄, and optionally additional water. For example, the paste comprises adding water to the acid-prewetted carbon additive, which is mixed to form a slurry. To the slurry is then added lignosulfonate, BaSO₄, and the lead-containing material (e.g., leady oxide) followed by mixing. To the mixture is added an additional volume of H₂SO₄ and optionally, additional water. In another example, the paste comprises adding water to the acid-prewetted carbon additive, which is mixed to form a slurry. To the slurry is then added lignosulfonate and BaSO₄, which is mixed. To this mixture is added the lead-containing material (e.g., leady oxide), additional water, and an additional volume of H₂SO₄.

In one embodiment, the paste is an electrode composition used to form an electrode.

In one embodiment, the slurry (e.g., a paste) is deposited (or otherwise pasted) onto a substrate, such as a plate or grid and allowed to dry on the substrate. In one embodiment, the plate or grid is a metallic structure that come in a myriad of designs and shapes (e.g., punched or expanded from sheets), functioning as the solid permanent support for the active material. The grid also conducts electricity or electrons to and away from the active material. Grids can comprise pure metals (e.g., Pb) or alloys thereof. The components of those alloys can comprise Sb, Sn, Ca, Ag, among other metals described in “Lead Acid Batteries,” Pavlov, Elsevier Publishing, 2011, the disclosure of which is incorporated herein by reference.

In one embodiment, the drying is achieved by a slow cure, such as under controlled humidity conditions and a moderate amount of heat (e.g., from 30 to 80° C. or from 35 to 60° C.) under controlled humidity, resulting in a porous solid. The curing step can then followed by a second heating step (drying) at an elevated temperature (e.g., from 50 to 140° C. or from 65 to 95° C.) at extremely low humidity, or even zero humidity. In one embodiment, the composition is a monolith. Other pasting, curing, and formation procedures are described in “Lead Acid Batteries,” Pavlov, Elsevier Publishing, 2011, the disclosure of which is incorporated herein by reference.

In one embodiment, the electrode is formed when the cured material that is deposited on the plate is subjected to a charging process. For example, this process can comprise immersing the cured, deposited material in a tank containing an H₂SO₄ solution and charging the material from 120% to 400% of theoretical capacity for a period of time, e.g., at least 2 h, e.g., from 2 h to 25 h.

### EXAMPLES

### Example 1

A carbon additive (5 g, PBX™ 135 carbon black additive, Cabot Corporation) was added to a beaker. Using a stirring rod to stir, sulfuric acid (14 g, 1.4 g/cm³) was added drop-wise to the additive. The beaker containing the acid-prewetted carbon black was then placed in a 100° C. oven overnight.

The dried acid-prewetted carbon black (2 mL) and deionized water (12 mL) were added to a centrifugation vial. The vial was vortexed for 30 s at 3000 rpm, and then centrifuged for 10 min @ 1300 rpm to form a pellet. The pellet was removed from the vial aided by deionized water from a squirt bottle, and the pellet and water were collected in a petri dish. The petri dish containing the carbon black was dried in an 80° C. convection oven for 4 h.

A similar procedure was performed as above, substituting the sulfuric acid for deionized water.

Table 1 below shows the results of surface energy analysis (SEP) performed on PBX™ 135 carbon black additive as well as the water and acid-prewetted samples.

TABLE 1

| Description | SEP (mJ/m²) |
|---|---|
| CB prewet with acid | 20.5 |
| CB prewet with water | 14.7 |
| CB as-made | 6.8 |

It can be seen that the surface energy of the carbon black is increased by prewetting with water, and further increased by prewetting with sulfuric acid.

### Example 2

This Example describes the preparation of a negative active material paste containing carbon additives, as well as electrodes made from the pastes.

A carbon additive (10 g, PBX™ 135 carbon black additive, Cabot Corporation) was added to a beaker. Using a plastic pipette, sulfuric acid (28 g, 1.28 g/cm³, battery electrolyte grade, d=1.28 g/cc) was added dropwise to the carbon black while stirring a spatula. The acid-prewetted carbon black was then added to a dry paste mixture containing PbO (1000 g), BaSO₄ (8 g), and Vanisperse A lignosulfonate (2 g). Water (127 mL) was added to the dry mixture and mixed for 10 min. To this mixture was added H₂SO₄ (112 g, 1.4 g/cm³) over a period of 13 min. The resulting slurry was stirred for 25 minutes to produce a NAM paste containing the carbon black at 1% loading. A control paste was prepared by adding 10 g, PBX™ 135 additive to the paste mixture of Table 2.

TABLE 2

| | | | | | water | |
|---|---|---|---|---|---|---|
| | | | Penetration | | from | Total |
| | Moisture | Density | Depth | water | prewet | water |
| Sample | content | (g/mL) | [units?] | (g) | (g) | (g) |
| CB acid | 14.28 | 3.57 | 9.5 | 127 | 28 | 145 |
| prewet | | | | | @37% | |
| CB control | 14.52 | 3.79 | 32.0 | 135 | 0 | 135 |

The negative plates were made of lead Pb-0.04 Ca-1.10 Sn alloy and had grid dimensions of 57 mm×60 mm×1.5 mm. The coated plates had a thickness of 2.5 mm. Curing was done for 72 hours at 35° C. and 98% relative humidity, followed by 24 hours at 60° C. and 10% relative humidity. The coated negative electrodes were formed by a tank formation process by using 1.06 g cm⁻³ H₂SO₄ solution and charging to 400% of theoretical capacity for 25 h.

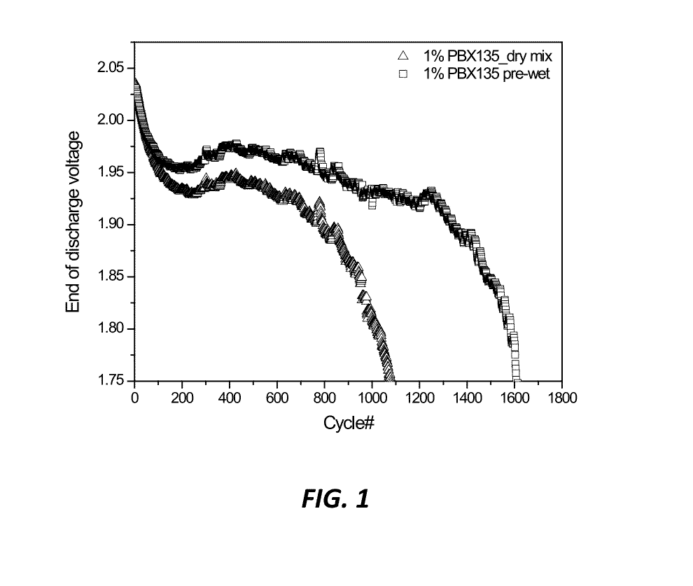

Flooded lead-acid single cells (2 V; filled with 1.28 g/cc sulfuric acid) of 4.8 Ah nominal capacity were assembled using two negative and three positive electrodes, with compressed electrodes and separator wrapped around the positive electrodes. The cells were tested for cycle-life by cycling at 50% state of charge, using C/3 discharge current for 30 minutes (17.5% depth of discharge) and C/3 recharge current for 40 minutes, until the end of discharge voltage reached 1.75 V. FIG. 1 is a plot of cycle no. as a function of end of discharge voltage. From FIG. 1, it can be seen that the cells containing acid-prewetted carbon additive achieved 1614 cycles, whereas the cells made with standard dry mixing procedures achieved 1156 cycles.

### Example 3

This Example describes alternative methods for acid-prewetting of carbon additives.

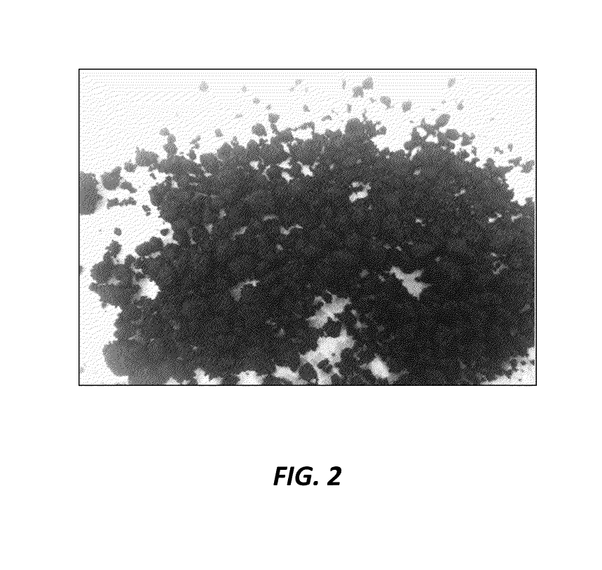

A carbon additive (10 g, PBX™ 135 carbon black additive) was weighed in a 250 mL beaker, and H₂SO₄ (28 g, 1.28 g/cm³) was weighed in a 100 mL beaker, added to the carbon additive and stirred. FIG. 2 is a photograph of the resulting wet powder. The wet powder was then added to the dry powder mix as described in Example 2 above.

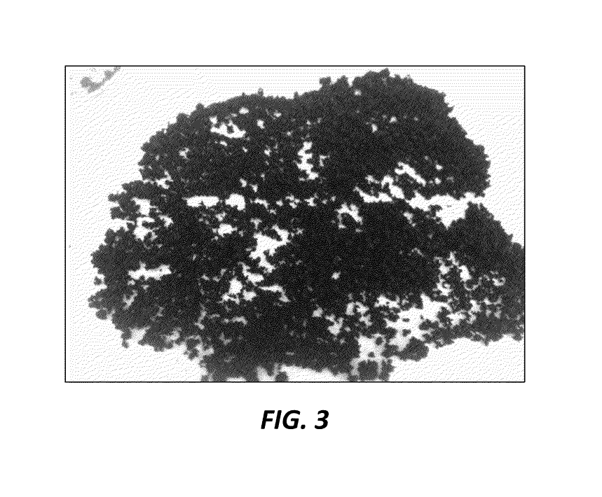

Alternatively, H₂SO₄ (28 g, 1.28 g/cm³) was weighed in a 250 mL beaker, and a carbon additive (10 g, PBX™ 135 carbon black additive) was weighed in a 100 mL beaker. The carbon additive was added to the H₂SO₄ and stirred. FIG. 3 is a photograph of the resulting wet powder. The wet powder was then added to the dry powder mix as described in Example 2 above.

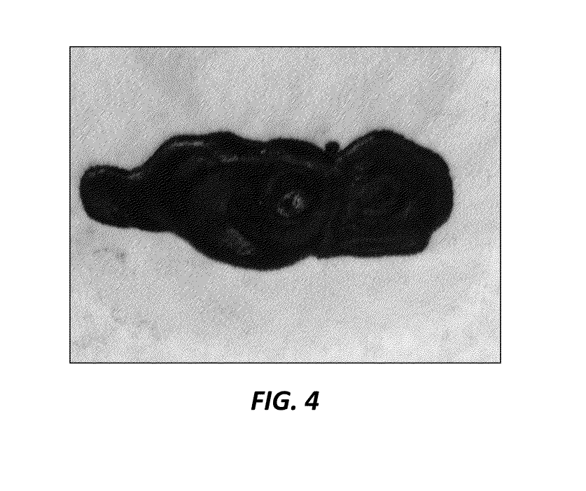

In a third alternative, deionized water (80 mL) was added to a 250 mL beaker. H₂SO₄ (28 g, 1.28 g/cm³) was then added to the water, followed by the addition of the carbon additive (10 g, PBX™ 135 carbon black additive). This mixture was stirred for 15 min. This resulted in slurry containing the carbon black. FIG. 4 is a photograph of the resulting slurry. The dry powder mix was then added to the slurry as described in Example 2 above.

Alternatively, the slurry could be added to the dry powder mix. These procedures can be used for mixing carbon black in a lead-acid paste reactor prior to adding the remaining paste constituents.

### Example 4

This Example describes water loss data for an electrode prepared from a paste containing an acid-prewetted carbon black. This electrode was compared to a control sample containing PBX™ 135 carbon black additive as is.

The paste was made according to Example 2, except the carbon black loading was 0.5 wt %. In other alternatives, the paste can be prepared according to Examples 1 or 3. The electrodes and cells were made according to Example 2.

Water loss for the cells was tested by placing the cells from in a water bath at 60° C. and applying a constant voltage of 2.4V for 1 week. The water loss was measured by the difference in cell weight before the start of the test and after 1 week of overcharge at 2.4V (the corresponding overcharge voltage for a full battery is 14.4V). The weight loss (water loss) is presented in Table 3 in [g].

TABLE 3

| Water loss test. 60° C. | 1st week, g |
|---|---|
| 0.5% CB as is | −8.0 |
| 0.5% CB acid prewet | −2.6 |

From Table 3, it can be seen that there is a decrease of water loss for an electrode prepared from an acid pre-wetted carbon additive (2.6 g water loss for 1 week) as compared to an electrode prepared from a carbon additive that was not prewetted with acid (8 g water loss).

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A composition comprising:
a carbon additive prewetted with H₂SO₄; and
a lead-containing material.

2. The composition of claim 1, wherein the carbon additive is selected from carbon black, graphene, graphite, and activated carbon.

3. (canceled)

4. The composition of claim 1, wherein the H₂SO₄ has a density ranging from 1.05 to 1.5 g/cm³.

5. The composition of claim 1, wherein the carbon black additive is carbon black prewetted with H₂SO₄ in an amount ranging from 0.8×OAN to 1.2×OAN of the carbon black.

6. The composition of claim 5, wherein the carbon black has an OAN ranging from 50 mL/100 g to 500 mL/100 g.

7. (canceled)

8. The composition of claim 1, wherein the lead-containing material is selected from lead, PbO, leady oxide, Pb₃O₄, Pb₂O, and PbSO₄, and hydroxides, acids, and metal complexes thereof.

9. The composition of claim 1, wherein the carbon additive prewetted with H₂SO₄ is present at a dry weight fraction of 0.1% to 5% by weight, relative to the total weight of the lead-containing material.

10. (canceled)

11. The composition of claim 1, wherein the total amount of the carbon additive prewetted with H₂SO₄ ranges from 0.1% to 1.5% by weight, relative to the total weight of the composition.

12. The composition of claim 1, wherein the composition further comprises an organic molecule expander.

13. (canceled)

14. (canceled)

15. The composition of claim 1, wherein the carbon additive has a BET surface area ranging from 1 m²/g to 2000 m²/g.

16. The composition of claim 1, wherein the carbon additive prewetted with H₂SO₄ is a powder.

17. The composition of claim 1, wherein the carbon additive prewetted with H₂SO₄ is a slurry.

18. The composition of claim 1, wherein the composition is a slurry.

19. The composition of claim 1, wherein the composition is a powder.

20. The composition of claim 1, wherein the composition is a homogeneous mixture.

21. An electrode prepared from the composition of claim 1.

22. A method of making a paste comprising a negative active material composition, comprising:
combining a carbon additive with H₂SO₄ to form an acid prewetted carbon additive; and
forming the paste comprising the acid prewetted carbon additive and a lead-containing material.

23. The method of claim 22, wherein the step of forming the paste comprises:
adding water to the acid-prewetted carbon additive to form a slurry, and
adding to the slurry, in any order, lignosulfonate, BaSO₄, the lead-containing material, an additional volume of H₂SO₄, and optionally additional water.

24. The method of claim 22, wherein a surface energy of the acid-prewetted carbon additive is at least 25% greater than that of the carbon additive, when measured in units mJ/m².

25. (canceled)

26. The method of claim 22, further comprising drying the slurry.

27. (canceled)
